(19) United States
(12) Patent Application Publication
(10) Pub. No.: US 2011/0046281 A1
(43) Pub. Date: Feb. 24, 2011

(54) POLYMER COMPOSITIONS HAVING POLY(LACTIC ACID)

(75) Inventors: Frederic Scheer, Hawthorne, CA (US); William Kelly, Hawthorne, CA (US); Gary Larrivee, Hawthorne, CA (US)

Correspondence Address: K&L Gates LLP, P.O. Box 1135, CHICAGO, IL, 60690, US

(73) Assignee: CEREPLAST, INC., Hawthorne, CA (US)

(21) Appl. No.: 12/543,955

(22) Filed: Aug. 19, 2009

(51) Int. Cl. C08K 5/20; B29C 47/00

(52) U.S. Cl. 524/210; 264/210.1; 264/210.2

(57) ABSTRACT

Polymer compositions having poly(lactic acid) and methods of making the polymer compositions are provided. In a general embodiment, the present disclosure provides a polymer composition including a poly(lactic acid), an acrylic chain extender additive, a copolyester, erucamide, and an ester compound made from the reaction of triple pressed stearic acid and polyethylene glycol

### BACKGROUND

The present disclosure relates to polymer compositions. More specifically, the present disclosure relates to biodegradable compositions, methods for making and using the biodegradable compositions and biodegradable articles made from the biodegradable compositions.

Packaging materials and disposable houseware items, cups and cutlery are used widely nowadays and allow food material to be sold and/or consumed under hygienic conditions. Such disposable materials and objects are highly desired by consumers and retailers because they may be simply disposed of after use and do not have to be washed and cleaned like conventional dishes, glasses or cutlery.

Unfortunately, the widespread and growing use of such disposable materials results in a mounting amount of litter produced each day. Currently, the plastic waste is either provided to garbage incinerators or accumulates in refuse dumps. These methods of waste disposal cause many problems for the environment.

Due to environmental concerns, biodegradable products are a fast growing segment for packaging materials and houseware items. Biodegradable materials made from lactide, poly lactic acid and related compounds are known. However, such polymers have limitations in terms of melt strength and chain extension.

### SUMMARY

Polymer compositions having poly(lactic acid) and methods of making the polymer compositions are provided. In a general embodiment, the present disclosure provides a polymer composition including a poly(lactic acid), an acrylic chain extender additive, a copolyester, erucamide, and an ester compound made from the reaction of triple pressed stearic acid and polyethylene glycol. In an embodiment, this new polymer composition is poly(alpha methyl hydroxycarboxylate)-G-Poly(butylenes-co-succinate adipate-co-terephthalate).

In an embodiment, the acrylic chain extender additive can be linear acrylic polymers, branched acrylic polymers, epoxyized acrylic polymers or a combination thereof. In another embodiment, the copolyester can be polycaprolactone, poly(butylenes-adipate-co-terephthalate) or a combination thereof.

In an embodiment, the erucamide ranges from about 0.1% to about 3% by weight of the polymer. In another embodiment, the ester compound ranges from about 0.2% to about 4% by weight of the polymer.

In an embodiment, the polymer composition can further include one or more components such as plasticizers, flow promoters, polymer processing aids, slip agents, viscosity modifiers, chain extenders, nanoparticles, spherical glass beads, organic fillers, inorganic fillers, fibers, colorants, anti-microbial agents or a combination thereof.

In another embodiment, the present disclosure provides a biodegradable article and a method of producing an article including a biodegradable polymer composition. The method comprises combining a poly(lactic acid), an acrylic chain extender additive, a copolyester, erucamide, and an ester compound made from the reaction of triple pressed stearic acid and polyethylene glycol produce a polymer blend. The method further comprises extruding the polymer blend to form an extrudate, and forming the extrudate into an article.

In an embodiment, the article can be in the form of polymer foams, toys, computer casing, DVDs, toiletries, combs, consumer products, cellular phone casings, bags, foam material products, packaging, automobile parts, cookware or a combination thereof.

In an embodiment, the forming is done by a process such as injection molding, thermoforming, film blowing, stretch blow molding, extrusion blow molding, extrusion coatings, profile extrusion, film extrusion, cast films, cast products or a combination thereof.

In an alternative embodiment, the present disclosure provides a method of making a polymer film. The method comprises combining a poly(lactic acid), an acrylic chain extender additive, a copolyester, erucamide, and an ester compound made from the reaction of triple pressed stearic acid and polyethylene glycol produce a polymer blend and forming a polymer film from the polymer blend. The method can further comprise applying the film to an article including a material such as paper, plastics, wood, composite materials or a combination thereof.

An advantage of the present disclosure is to provide an improved biodegradable composition.

Another advantage of the present disclosure is to provide a method of making an improved biodegradable composition.

Yet another advantage of the present disclosure is to provide articles having an improved biodegradability.

Still another advantage of the present disclosure is to provide biodegradable articles having improved melt strength.

A further advantage of the present disclosure is to provide improved biodegradable articles having an improved chain extension.

Additional features and advantages are described herein, and will be apparent from the following Detailed Description and the figures.

### BRIEF DESCRIPTION OF THE FIGURES

FIG. 1 shows the structure of poly(alpha methyl hydroxycarboxylate)-G-Poly (butylenes-co-succinate adipate-co-terephthalate)

FIG. 2 shows haul off test results for Sample #1, Sample #2 and Sample #3 at 180° C.

FIG. 3 shows viscometry test results for Sample #1, Sample #2 and Sample #3.

### DETAILED DESCRIPTION

Polymer compositions having poly(lactic acid) (“PLA”) and methods of making and using the polymer compositions are provided. The polymer compositions further include erucamide and have improved melt strength and chain extension as compared to typical PLA containing polymers. The polymer compositions can be biodegradable and used to give products biodegradable properties. In addition, the polymer compositions can be made using co-rotating Twin Screw extruders for extrusion and also blending and mixing methods with high speed blenders and/or ribbon blenders depending of the characteristics of the polymer compositions that are desired.

PLA may be represented by the following structure:

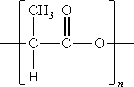

wherein n for example can be an integer between 10 and 250. PLA can be prepared according to any method known in the state of the art. For example, PLA can be prepared from lactic acid and/or from one or more of D-lactide (i.e. a dilactone, or a cyclic dimer of D-lactic acid), L-lactide (i.e. a dilactone, or a cyclic dimer of L-lactic acid), meso D,L-lactide (i.e. a cyclic dimer of D- and L-lactic acid), and racemic D,L-lactide (racemic D,L-lactide comprises a 1/1 mixture of D- and L-lactide).

PLAs resemble clear polystyrene and have good gloss and clarity for aesthetic appeal, along with physical properties well suited for use as fibers, films, and thermoformed packaging. PLA is biocompatible and has been used extensively in medical and surgical applications, e.g. sutures and drug delivery devices. Unfortunately, PLA present major weaknesses such as brittleness as well as low thermal resistance, 136° F. (58° Celsius) and moisture-related degradation, limiting a lot of commercial applications.

It has been surprisingly found that the polymer compositions according to embodiments of the present disclosure provide physical properties that are not inherent to poly(lactic acid) and provide significant improvements with respect to the processability, production costs or heat resistance along with improved flexibility and ductility without decreasing their biodegradability.

In a general embodiment, the present disclosure provides a polymer composition including a PLA, an acrylic chain extender additive, a copolyester, erucamide, and an ester compound made from the reaction of triple pressed stearic acid and polyethylene glycol. The PLA can be in an amount ranging from about 55% to about 95% by weight and preferably from about 70% to about 85% by weight of the polymer composition.

Erucamide is also known chemically as 13-docosenamide or erucic amide. The erucamide can range from about 0.1% to about 3% by weight and preferably from about 0.3% to about 0.8% by weight of the polymer composition.

The ester compound can be made from a reaction of stearic acid and 6,000 MW—polyethylene glycol (“PEG”). An example of the ester compound includes polyethylene glycol distearate. The ester compound can range from about 0.2% to about 4% by weight and preferably from about 0.4% to about 2% by weight of the polymer.

In an embodiment, the acrylic chain extender additive can be linear acrylic polymers, branched acrylic polymers, epoxyized acrylic polymers or a combination thereof. The linear acrylic polymers can range from about 3% to about 12% by weight and preferably from 6% to about 8% by weight of the polymer composition. The branched acrylic polymers can range from about 1% to about 6% by weight and preferably from 2% to about 4% by weight of the polymer composition. The epoxyized acrylic polymers can range from about 0.2% to about 1.5% by weight and preferably from 0.5% to about 1% by weight of the polymer composition.

In another embodiment, the copolyester can be polycaprolactone, poly(butylenes-adipate-co-terephthalate) or a combination thereof. The polycaprolactone can range from about 0.3% to about 25% by weight and preferably from 0.3% to about 5% by weight of the polymer composition. The poly(butylenes-adipate-co-terephthalate) can range from about 5% to about 30% by weight and preferably from 12% to about 25% by weight of the polymer composition.

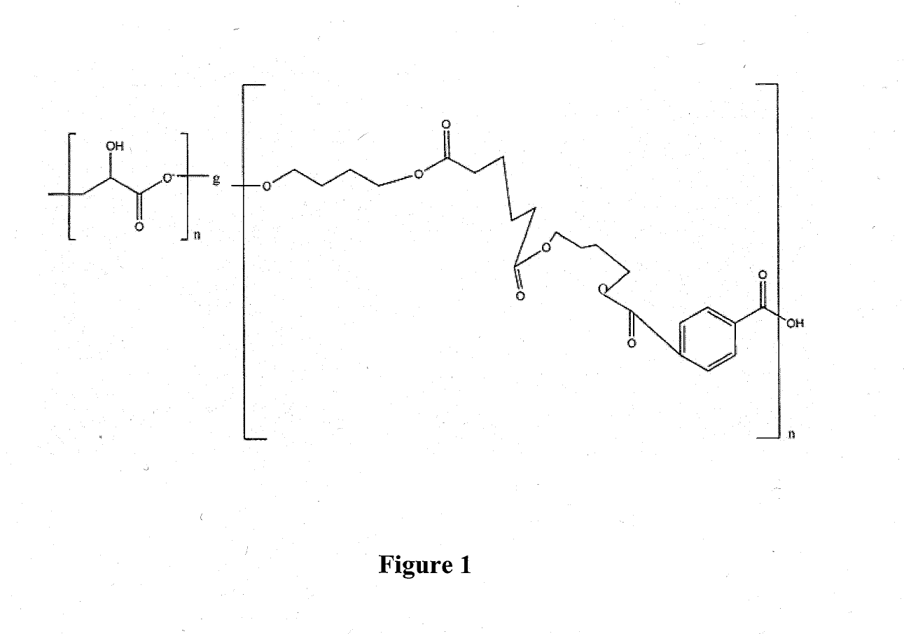

In an embodiment, the polymer composition is poly(alpha methyl hydroxycarboxylate)-G-Poly(butylenes-co-succinate adipate-co-terephthalate). Poly(alpha methyl hydroxycarboxylate)-G-Poly(butylenes-co-succinate adipate-co-terephthalate) has a structure as shown in FIG. 1, wherein n for example can be an integer (g=grafted).

In another embodiment, the polymer compositions of the present disclosure can include formulations that are modified with one or more plasticizers, flow promoters, polymer processing aids, slip agents, viscosity modifiers, chain extenders, nanoparticles, spherical glass beads, organic fillers, inorganic fillers, fibers, colorants, anti-microbial agents and the like.

The plasticizers can be, for example, any suitable material that softens and/or adds flexibility to the materials they are added to. The plasticizers can soften the final product increasing its flexibility. Non-limiting examples of the plasticizers include, for example, polyethylene glycol, sorbitol, glycerine, soybean oil, caster oil, TWEEN 20, TWEEN 40, TWEEN 60, TWEEN 80, TWEEN 85, sorbitan monolaurate, sorbitan monooleate, sorbitan monopalmitate, sorbitan trioleate, sorbitan monostearate, PEG, derivatives of PEG, N,N-ethylene bis-stearamide, N,N-ethylene bis-oleamide, polymeric plasticizers such as poly(1,6-hexamethylene adipate) or combination thereof.

Non-limiting examples of organic fillers include wood flour, seeds, polymeric particles, ungelatinized starch granules, cork, gelatins, wood flour, saw dust, milled polymeric materials, agar-based materials, and the like. Examples of inorganic fillers include calcium carbonate, titanium dioxide, silica, talc, mica, sand, gravel, crushed rock, bauxite, granite, limestone, sandstone, glass beads, aerogels, xerogels, clay, alumina, kaolin, microspheres, hollow glass spheres, porous ceramic spheres, gypsum dihydrate, insoluble salts, magnesium carbonate, calcium hydroxide, calcium aluminate, magnesium carbonate, ceramic materials, pozzolanic materials, salts, zirconium compounds, xonotlite (a crystalline calcium silicate gel), lightweight expanded clays, perlite, vermiculite, hydrated or unhydrated hydraulic cement particles, pumice, zeolites, exfoliated rock, ores, minerals, and the like. A wide variety of other inorganic fillers may be added as starting materials to the biodegradable compositions including, for example, metals and metal alloys (e.g., stainless steel, iron, and copper), balls or hollow spherical materials (such as glass, polymers, and metals), filings, pellets, flakes and powders (such as microsilica).

Non-limiting examples of fibers that may be incorporated into the biodegradable compositions include naturally occurring organic fibers, such as cellulosic fibers extracted from wood, plant leaves, and plant stems. These organic fibers can be derived from cotton, wood fibers (both hardwood or softwood fibers, examples of which include southern hardwood and southern pine), flax, abaca, sisal, ramie, hemp, and bagasse. In addition, inorganic fibers made from glass, graphite, silica, ceramic, rock wool, or metal materials may also be used.

Non-limiting examples of anti-microbial agents include metal-based agents such as zinc oxide, copper and copper compounds, silver and silver compounds, colloidal silver, silver nitrate, silver sulphate, silver chloride, silver complexes, metal-containing zeolites, surface-modified metal-containing zeolites or combination thereof. The metal-containing zeolites can include a metal such as silver, copper, zinc, mercury, tin, lead, bismuth, cadmium, chromium, cobalt, nickel, zirconium or a combination thereof. In another embodiment, the anti-microbial agents can be organic-based agents such as o-benzyl-phenol, 2-benzyl-4-chloro-phenol, 2,4,4′-trichloro-2′-hydroxydiphenyl ether, 4,4′-dichloro-2-hydroxydiphenyl ether, 5-chloro-2-hydroxy-diphenyl-methane, mono-chloro-o-benzyl-phenol, 2,2′-methylenbis-(4-chloro-phenol), 2,4,6-trichlorophenol or a combination thereof.

The polymer compositions of the present disclosure may be used for the production of various articles, such as e.g. molded articles and/or extruded articles. The term “molded article” (or “extruded article”) as used in the present disclosure includes articles made according to a molding process (or an extrusion process). A “molded article” (or “extruded article”) can also be part of another object, such as e.g. an insert in a container or a knife blade or fork insert in a corresponding handle. Injection molding, profile extrusion and thermoform extrusion are processes known to a skilled person and are described for example in Modern Plastics Encyclopedia, Published by McGraw-Hill, Inc. mid-October 1991 edition.

Extruded articles include, for example, films, trash bags, grocery bags, container sealing films, pipes, drinking straws, spun-bonded non-woven materials, and sheets. Articles according to the present disclosure made from a profile extrusion formulation are, for example, drinking straws and pipes. Articles according to the present disclosure made from a thermoform extrusion method are, for example, sheets for producing cups, plates and other objects that could be outside of the food service industry.

### EXAMPLES

By way of example and not limitation, the following examples are illustrative of various embodiments of the present disclosure. The formulations below are provided for exemplification only, and they can be modified by the skilled artisan to the necessary extent, depending on the special features that are looked for.

### Example 1

### Objectives

An objective was to provide rheological measurements of several PLA samples with the goal of comparing results with viscometry and Haul off to determine the melt strength and the suitability of the Rosand Capillary Rheometer for these samples.

### Introduction & Background

Three samples were submitted for rheological measurements using the Rosand RH7 instrument. The samples were:

### Sample #1

| Component | Weight % |
|---|---|
| PLA | 88% |
| Copolyester | 3% |
| Linear acrylic copolymer | 8% |
| Polyethylene glycol distearate | 0.5% |
| Erucamide | 0.5% |

### Sample #2

| Component | Weight % |
|---|---|
| PLA | 92% |
| Linear acrylic copolymer | 4% |
| Branched acrylic copolymer | 2% |
| Branched acrylic agent | 2% |

### Sample #3

| Component | Weight % |
|---|---|
| PLA | 88% |
| Linear acrylic copolymer | 8% |
| Branched acrylic copolymer | 2% |
| Branched acrylic agent | 2% |

All samples were palletized plastic.

A Synopsis of Capillary Rheology—In the Rosand capillary rheometer, a sample is loaded in a cylindrical barrel where it is heated to the pre-set temperature and then piston extruded through a cylindrical orifice (die) in place at the bottom. The pressure drop down the die is accurately measured with a pressure transducer placed just above the die. This is preferable to the alternative method of measuring the pressure on the top of the piston, which would also show the piston's friction in the barrel.

The Rosand capillary rheometers can accommodate a wide range of pressure transducers and dies, making them versatile for measuring a broad spectrum of sample types. Typical sample viscosities can range from ink jet ink to high density rubber samples. The standard instrument's temperature range is generally from ambient to 400° C. (with cryogenic cooling and 500° C. max temperature as options).

Capillary rheometers can be used to generate shear viscosity, extensional viscosity and elasticity measurements. Also, there are modes for thermal degradation tests, pressure volume temperature (“PVT”) tests, haul-off (fibre spinning), stress relaxation, wall slip analysis and many more.

### Methodology & Instrumentation

For measurement of these samples, the Rosand RH7 capillary rheometer with 15 mm barrel with a haul off system was used. The standard 2 mm×20 mm haul off die was used, for the haul off measurements and the 1 mm×16 mm standard capillary die was used for the viscometry measurements. This set-up uses about 45 mls of sample per test. The measurements were done at 180° C. for all samples, except for Sample #3 where other temperatures were also used to see whether the melt strength could be improved. All three samples were dried at around 70° C. under vacuum for several hours.

### Haul off Test Parameters

Die—2 mm×20 mm×180×15

Transducer—3000 PSI

Threading Parameters—10 mm/min piston speed, 10 m/min haul off speed

During Test—25 mm/min piston speed, haul off speed ramping from 10-1000 m/min in 5 mins, 30 results.

Temperature—180° C.

### Flow Curve Test Parameters:

Die—1 mm×16 mm×180×15

Transducer—3000 PSI

Pretest—compress to 1 Mpa at 100 mm/min, wait 4 mins; compress to 1 Mpa at 100 mm/min, wait 3 mins

Parameters—20 —5000 1/s Log, UP, 8 points

Equilibrium Conditions—Sampling: V6 mode at the standard rate; No filter

Pressure stability—1) 0.2%; 2) 3; 3) 6; 4) no limit

Temperature—180° C.

### Results

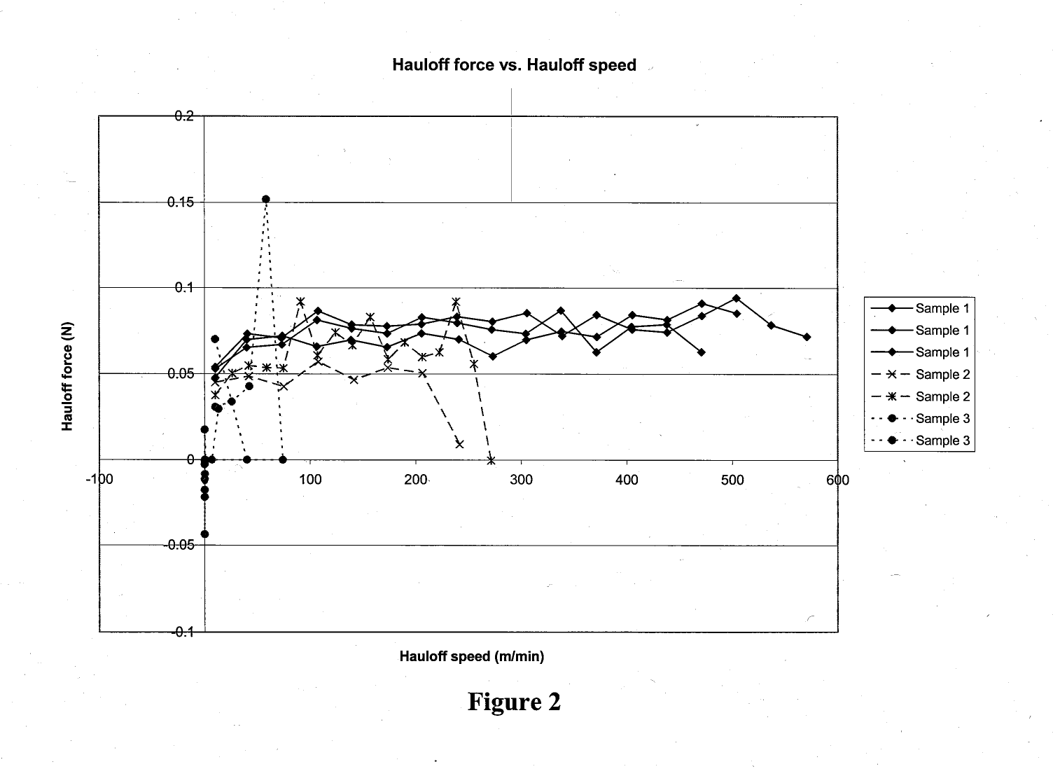

Haul off/Melt strength tests—FIG. 2 shows haul off test results for Sample #1, Sample #2 and Sample #3 at 180° C. Equilibrium Data. From FIG. 2, Sample #1 clearly has the best haul off results—meaning it demonstrates the best elastic behavior coming out of the melt. Sample #1 showed a higher melt strength and maximum haul off speed than both or the other two samples. Sample #2 was reasonably strong and able to be fibre spun. However, Sample #3 was very weak.

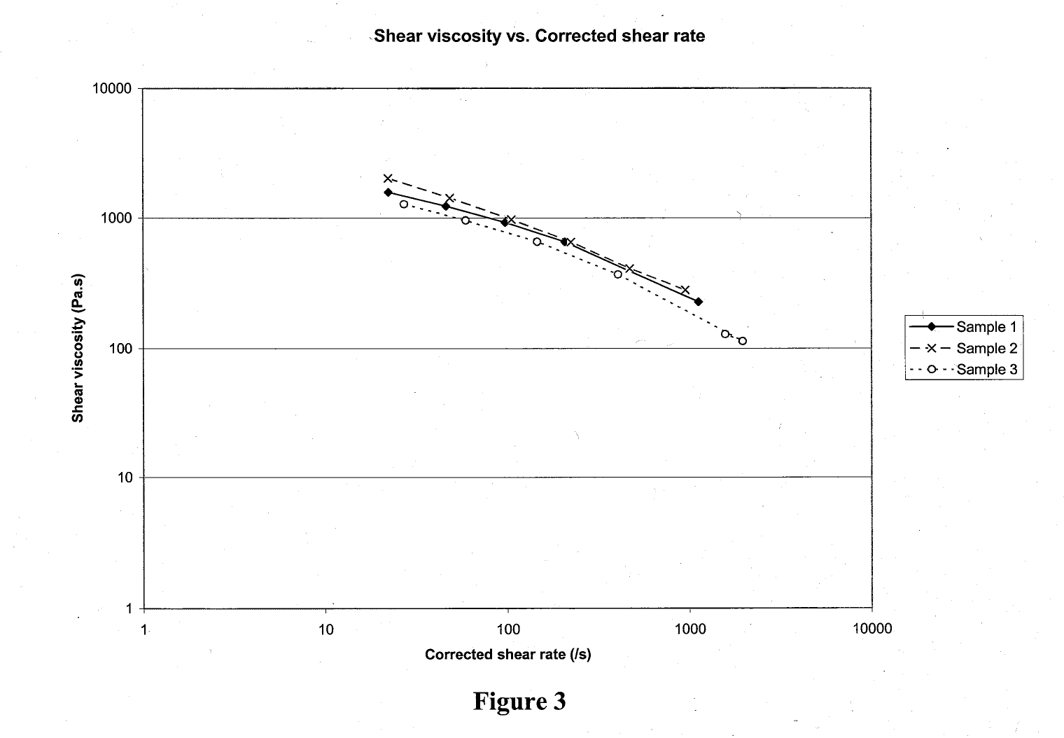

Viscometry Test Results—FIG. 3 shows viscometry test results for Sample #1, Sample #2 and Sample #3 at 180° C. From FIG. 3, one can clearly see that Sample #2 has the highest viscosity versus shear rate, which would indicate better melt behavior allowing for better bubble formation. All three samples were shear thinning in nature, with Sample #3 having the lowest shear viscosity, followed by Sample #1 and then followed by Sample #2. The viscosity results did not correlate with the melt strength data, although it may be that there is an optimum viscosity to do haul off tests.

### Discussion

The drying of the samples was important to the success of these tests, as bubbles in the melt (caused by water vapor in the melt boiling) can cause the melt to break when under tension. The Rosand RH7 rheometer was useful to determine the viscosity characteristics of the melt and the melt strength in a simulated haul off experiment.

### CONCLUSIONS

The haul-off and viscometry sweep data were obtained for each sample on the Rosand capillary rheometer using just two dies. The results showed that the three samples were very different in their melt strengths and in their viscosity profiles. The laboratory tests show that the Rosand RH7 is suitable for measurement of these samples using only around 100 mls of sample for each suite of analyses.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A polymer composition comprising:
a poly(lactic acid),
an acrylic chain extender additive,
a copolyester,
erucamide, and
an ester compound made from the reaction of triple pressed stearic acid and polyethylene glycol.

2. The polymer composition of claim 1, wherein the acrylic chain extender additive is selected from the group consisting of linear acrylic polymers, branched acrylic polymers, epoxyized acrylic polymers and combinations thereof.

3. The polymer composition of claim 1, wherein the copolyester is selected from the group consisting of polycaprolactone, poly(butylenes-adipate-co-terephthalate) and combinations thereof.

4. The polymer composition of claim 1, wherein the erucamide ranges from about 0.1% to about 3% by weight of the polymer.

5. The polymer composition of claim 1, wherein the ester compound ranges from about 0.2% to about 4% by weight of the polymer.

6. The polymer composition of claim 1 further comprising at least one component selected from the group consisting of plasticizers, flow promoters, polymer processing aids, slip agents, viscosity modifiers, chain extenders, nanoparticles, spherical glass beads, organic fillers, inorganic fillers, fibers, colorants, anti-microbial agents and combinations thereof.

7. The polymer composition of claim 1, wherein the polymer composition is poly(alpha methyl hydroxycarboxylate)-G-Poly(butylenes-co-succinate adipate-co-terephthalate).

8. A method of producing an article comprising a biodegradable polymer composition, the method comprising:
combining a poly(lactic acid), an acrylic chain extender additive, a copolyester, erucamide, and an ester compound made from the reaction of triple pressed stearic acid and polyethylene glycol produce a polymer blend;
extruding the polymer blend to form an extrudate; and
forming the extrudate into an article.

9. The method of claim 8, wherein the article is selected from the group consisting of polymer foams, toys, computer casing, DVDs, toiletries, combs, consumer products, cellular phone casings, bags, foam material products, packaging, automobile parts, cookware and combinations thereof.

10. The method of claim 8, wherein the forming is done by a process selected from the group consisting of injection molding, thermoforming, film blowing, stretch blow molding, extrusion blow molding, extrusion coatings, profile extrusion, film extrusion, cast films, cast products and combinations thereof.

11. The method of claim 8, wherein the acrylic chain extender additive is selected from the group consisting of linear acrylic polymers, branched acrylic polymers, epoxyized acrylic polymers and combinations thereof.

12. The method of claim 8, wherein the copolyester is selected from the group consisting of polycaprolactone, poly(butylenes-adipate-co-terephthalate) and combinations thereof.

13. The method of claim 8, wherein the erucamide ranges from about 0.1% to about 3% by weight of the polymer.

14. The method of claim 8, wherein the polymer blend further comprises at least one component selected from the group consisting of plasticizers, flow promoters, polymer processing aids, slip agents, viscosity modifiers, chain extenders, nanoparticles, spherical glass beads, organic fillers, inorganic fillers, fibers, colorants, anti-microbial agents and combinations thereof.

15. A method of making a polymer film, the method comprising:
combining a poly(lactic acid), an acrylic chain extender additive, a copolyester, erucamide, and an ester compound made from the reaction of triple pressed stearic acid and polyethylene glycol produce a polymer blend; and
forming a polymer film from the polymer blend.

16. The method of claim 15 comprising applying the film to an article comprising a material selected from the group consisting of paper, plastics, wood, composite materials and combinations thereof.

17. The method of claim 15, wherein the acrylic chain extender additive is selected from the group consisting of linear acrylic polymers, branched acrylic polymers, epoxyized acrylic polymers and combinations thereof.

18. The method of claim 15, wherein the copolyester is selected from the group consisting of polycaprolactone, poly(butylenes-adipate-co-terephthalate) and combinations thereof.

19. The method of claim 15, wherein the polymer blend further comprises at least one component selected from the group consisting of plasticizers, flow promoters, polymer processing aids, slip agents, viscosity modifiers, chain extenders, nanoparticles, spherical glass beads, organic fillers, inorganic fillers, fibers, colorants, anti-microbial agents and combinations thereof.

20. A biodegradable article comprising:
a polymer composition comprising a poly(lactic acid), an acrylic chain extender additive, a copolyester, erucamide, and an ester made from the reaction of triple pressed stearic acid and polyethylene glycol.
